(19) United States
(12) Patent Application Publication
(10) Pub. No.: US 2013/0201121 A1
(43) Pub. Date: Aug. 8, 2013

(54) TOUCH DISPLAY DEVICE AND TOUCH METHOD

(71) Applicants: Li-Zong Chen, New Taipei City (TW); Chia-Hsiang Yang, New Taipei City (TW)

(72) Inventors: Li-Zong Chen, New Taipei City (TW); Chia-Hsiang Yang, New Taipei City (TW)

(21) Appl. No.: 13/597,274

(22) Filed: Aug. 29, 2012

(30) Foreign Application Priority Data
Feb. 8, 2012 (TW) 101104016

(51) Int. Cl. G06F 3/041

(52) U.S. Cl. 345/173

(57) ABSTRACT

A touch display device includes a display panel, a touch panel, a storage unit and a processor, wherein the processor is electrically connected to the display panel, the touch panel and the storage unit. The storage unit is used for storing an operating system and an application. The processor is used for executing the operating system and the application in the display panel. When the processor detects that a first touch object presses a predetermined corner of the touch panel and detects that a second touch object performs a predetermined gesture within a predetermined region of the touch panel, the processor executes a predetermined function in the application according to signals generated by the touch panel and controls the display panel to display an executed result corresponding to the predetermined function.

### BACKGROUND OF THE INVENTION

1. Field of the Invention

The invention relates to a touch display device and a touch method and, more particularly, to a touch display device and a touch method capable of executing a predetermined function in an application in response to a simple gesture correspondingly.

2. Description of the Prior Art

Since consumer electronic products have become more and more lighter, thinner, shorter, and smaller, there is no space on these products for containing a conventional input device, such as a mouse, a keyboard, etc. With development of touch technology, in various kinds of consumer electronic products (e.g. a tablet personal computer, a mobile phone, or a personal digital assistant (PDA)), a touch panel has become a main tool for data input. Though the touch panel is a very convenient input device, so far the touch panel is still not good enough in operation. For example, if a user wants to open new page, close current page or change page in a browser, he or she has to call out a function menu first and then clicks the desired function correspondingly. Furthermore, if the user wants to close an application displayed in the display panel currently, he or she has to open application management function first so as to terminate the application. The aforesaid operations are complicated and inconvenient for the user.

### SUMMARY OF THE INVENTION

The invention provides a touch display device and a touch method capable of executing a predetermined function in an application in response to a simple gesture correspondingly, so as to solve the aforesaid problems.

According to an embodiment of the invention, a touch display device comprises a display panel, a touch panel, a storage unit and a processor, wherein the processor is electrically connected to the display panel, the touch panel and the storage unit . The storage unit is used for storing an operating system and an application. The processor is used for executing the operating system and the application in the display panel. When the processor detects that a first touch object presses a predetermined corner of the touch panel and detects that a second touch object performs a predetermined gesture within a predetermined region of the touch panel, the processor executes a predetermined function in the application according to signals generated by the touch panel and controls the display panel to display an executed result corresponding to the predetermined function.

According to another embodiment of the invention, a touch method is adapted for a touch display device, wherein the touch display device comprises a touch panel, an operating system and at least one application. The touch method comprises steps of executing the operating system and the at least one application; detecting whether a first touch object presses a predetermined corner of the touch panel; detecting whether a second touch object performs a predetermined gesture within a predetermined region of the touch panel; and executing a predetermined function in the application according to detection result correspondingly.

As mentioned in the above, when a user wants to operate the touch display device of the invention to execute the predetermined function in the application (e.g. close the application, open new page, close current page, change page, etc.), he or she has to press the predetermined corner of the touch panel by the first touch object (e.g. one hand of the user) first and then performs the predetermined gesture within the predetermined region of the touch panel (e.g. press another corner of the touch panel or slide screen on the touch panel) by the second touch object (e.g. the other hand of the user). Afterward, the processor is triggered to execute the predetermined function in the application correspondingly. Accordingly, the user can utilize simple gesture to execute the predetermined function in the application instead of complicated and inconvenient operations of the prior art.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a touch display device according to an embodiment of the invention.

FIG. 2 is a functional block diagram illustrating the touch display device shown in FIG. 1.

FIG. 3 is a flowchart illustrating a touch method according to an embodiment of the invention.

FIG. 4 is a schematic diagram illustrating the touch display device shown in FIG. 1 being used to execute a predetermined function, which is executed to close the application.

FIG. 5 is a schematic diagram illustrating the touch display device shown in FIG. 1 being used to execute a predetermined function, which is executed to change page in the application.

FIG. 6 is a schematic diagram illustrating the touch display device shown in FIG. 1 being used to execute a predetermined function, which is executed to change page between bottom and top in the application.

FIG. 7 is a schematic diagram illustrating the touch display device shown in FIG. 1 being used to execute a predetermined function, which is executed to open a new page in the application.

FIG. 8 is a schematic diagram illustrating the touch display device shown in FIG. 1 being used to execute a predetermined function, which is executed to close a current page in the application.

### DETAILED DESCRIPTION

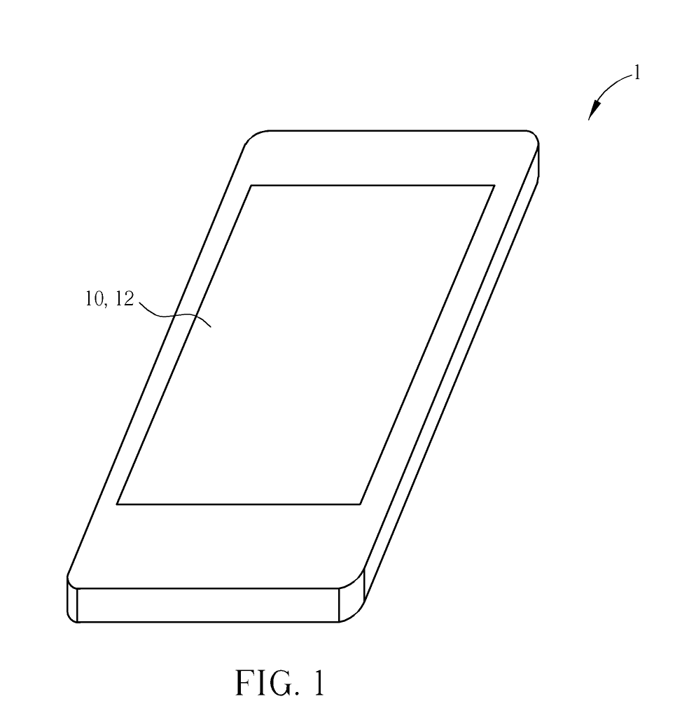

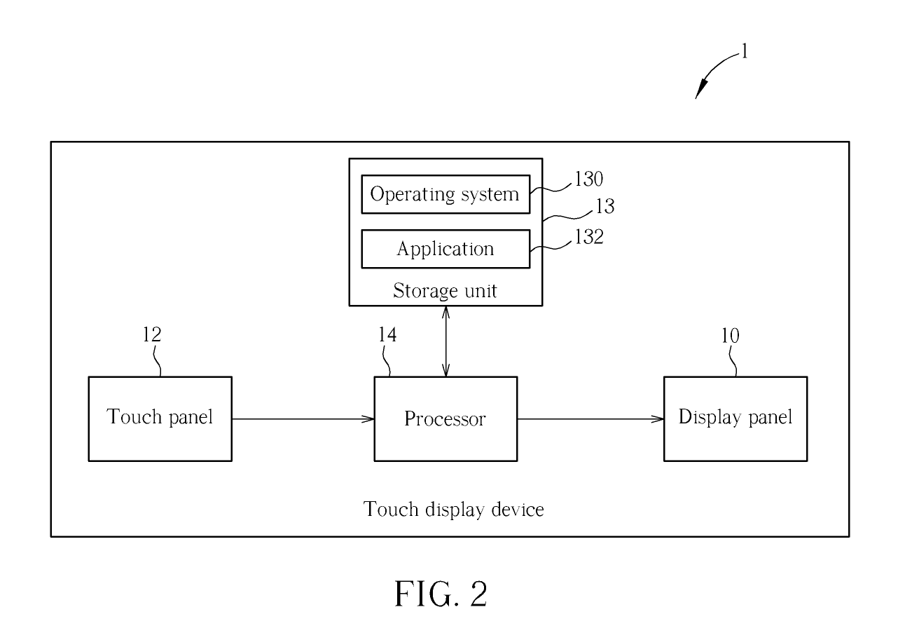

Referring to FIGS. 1 and 2, FIG. 1 is a schematic diagram illustrating a touch display device 1 according to an embodiment of the invention, and FIG. 2 is a functional block diagram illustrating the touch display device 1 shown in FIG. 1. The touch display device 1 comprises a display panel 10, a touch panel 12, a storage unit 13 and a processor 14, wherein the processor 14 is electrically connected to the display panel 10, the touch panel 12 and the storage unit 13. In practical applications, the touch display device 1 may be any electronic devices with data processing function, touch function and display function (e.g. tablet personal computer, mobile phone, or personal digital assistant), the display panel 10 may be a liquid crystal display device or other display devices, the storage unit 13 may be a hard disc or other storage devices capable of storing data, and the processor 14 maybe a processor or controller with data processing function. In general, the touch panel 12 is disposed in the display panel 10 so the display panel 10 and the touch panel 12 are labeled at the same position in FIG. 1. In this embodiment, the storage unit 13 is used for storing an operating system 130 and an application 132. In practical applications, the operating system 130 may be Windows Mobile, Google Android OS, Palm OS, Blackberry OS, Apple iOS, Symbian OS or other operating systems, and the application 132 may be web browser application, photo browser application, document editor application, trial balance application or other applications. The processor 14 of the touch display device 1 will execute the operating system 130 in the display panel 10 when booting. A user can operate the touch display device 1 to execute the application 132 in the display panel 10 by the processor 14 after the touch display device 1 is ready.

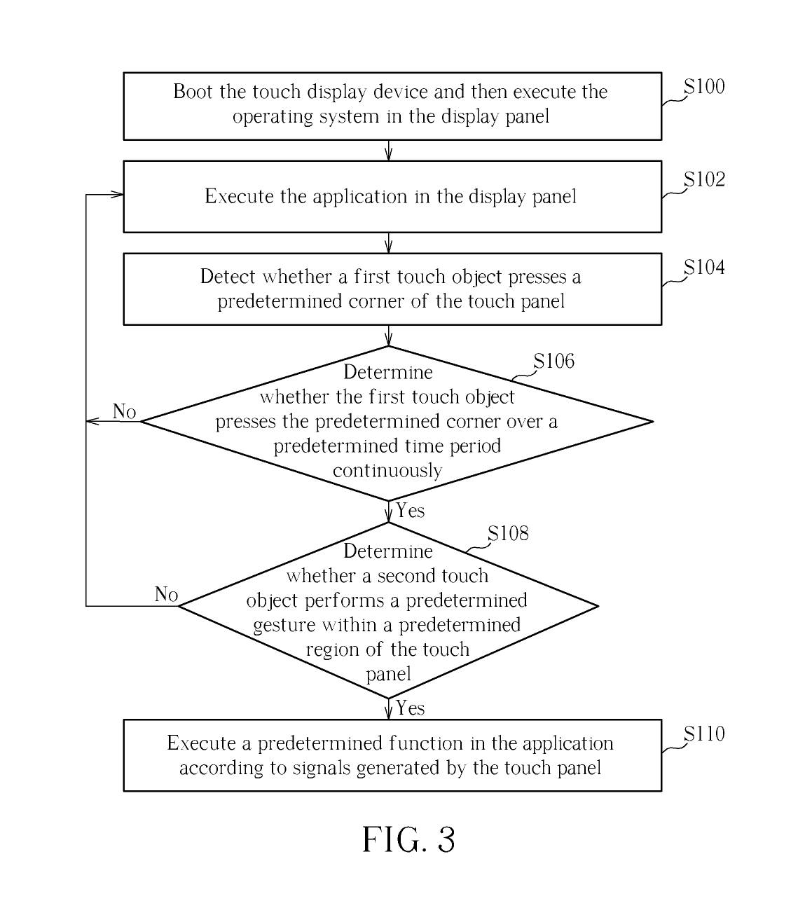

Referring to FIG. 3, FIG. 3 is a flowchart illustrating a touch method according to an embodiment of the invention. As shown in FIG. 3, first of all, step S100 is performed to boot the touch display device 1 and then execute the operating system 130 in the display panel 10 by the processor 14. Afterward, step S102 is performed to execute the application 132 in the display panel 10 by the processor 14. Step S104 is then performed to detect whether a first touch object presses a predetermined corner of the touch panel 12. After detecting that the first touch object presses the predetermined corner of the touch panel 12, step S106 is performed to determine whether the first touch object presses the predetermined corner over a predetermined time period continuously by the processor 14 (e.g. three seconds, five seconds or other time period based on practical applications). Once the first touch object presses the predetermined corner of the touch panel 12 over the predetermined time period continuously, step S108 is performed to determine whether a second touch object performs a predetermined gesture within a predetermined region of the touch panel 12 by the processor 14. If the first touch object does not press the predetermined corner of the touch panel 12 over the predetermined time period continuously, step S102 will be performed again. Once the second touch object performs the predetermined gesture within the predetermined region of the touch panel 12, step S110 is performed to execute a predetermined function in the application 132 according to signals generated by the touch panel 12. If the predetermined gesture does not be performed by the second touch object within the predetermined region of the touch panel 12, step S102 will be performed again. The first touch object and the second touch object may be fingers of both hands of the user, styluses or other objects capable of operating the touch panel 12.

The features of the invention will be depicted in the following by several embodiments using the touch display device 1 shown in FIGS. 1 and 2 and the touch method shown in FIG. 3.

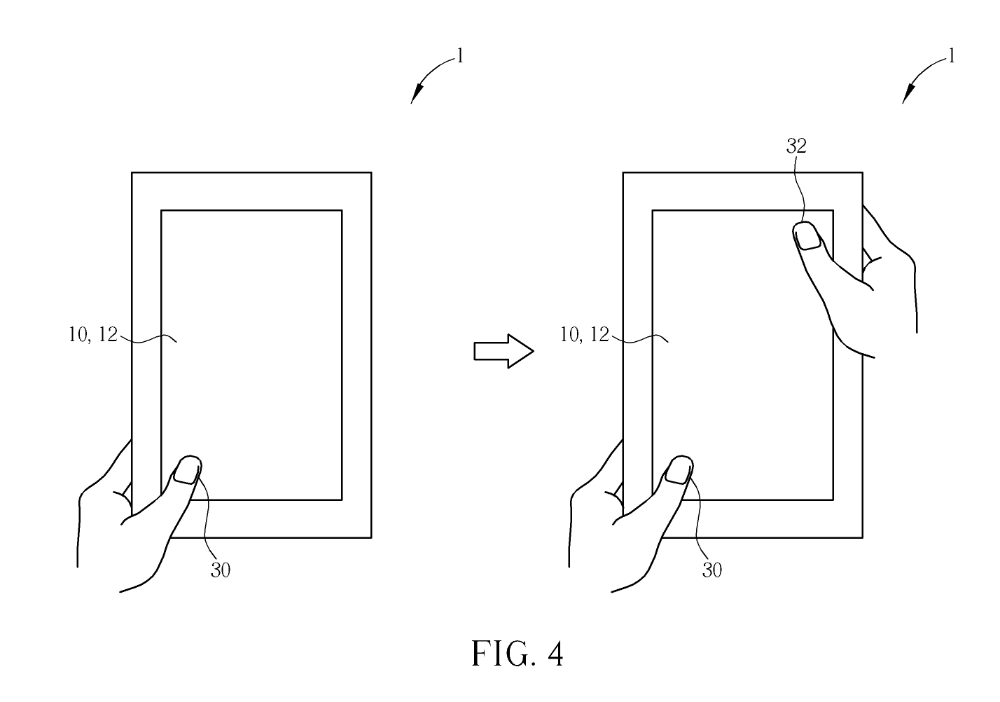

Referring to FIG. 4, FIG. 4 is a schematic diagram illustrating the touch display device 1 shown in FIG. 1 being used to execute a predetermined function, which is executed to close the application 132. As shown in FIG. 4, when a user wants to operate the touch display device 1 to execute a predetermined function, which is executed to close the application 132, he or she has to press a lower left corner (i.e. predetermined corner) of the touch panel 12 by a first touch object 30 first and then presses an upper right corner of the touch panel 12 diagonal to the lower left corner by a second touch object 32 (i.e. the aforesaid predetermined region is the upper right corner diagonal to the lower left corner and the aforesaid predetermined gesture is a press gesture) while the first touch object 30 presses the lower left corner of the touch panel 12 continuously. Afterward, the processor 14 will close the application 132 displayed in the display panel 10 currently according to signals generated by the touch panel 12 (i.e. predetermined function).

In this embodiment, the user can also press an upper left corner of the touch panel 12 by the first touch object 30 first and then presses a lower right corner of the touch panel 12 diagonal to the upper left corner by the second touch object 32, so as to close the application 132 displayed in the display panel 10 currently. Furthermore, the user can also press a lower right corner of the touch panel 12 by the first touch object 30 first and then presses an upper left corner of the touch panel 12 diagonal to the upper left corner by the second touch object 32, so as to close the application 132 displayed in the display panel 10 currently. Moreover, the user can also press an upper right corner of the touch panel 12 by the first touch object 30 first and then presses a lower left corner of the touch panel 12 diagonal to the upper right corner by the second touch object 32, so as to close the application 132 displayed in the display panel 10 currently.

In other words, to close the application 132 displayed in the display panel 10 currently, the user has to press two corners diagonal to each other so as to prevent the application 132 from being closed due to mis-operation.

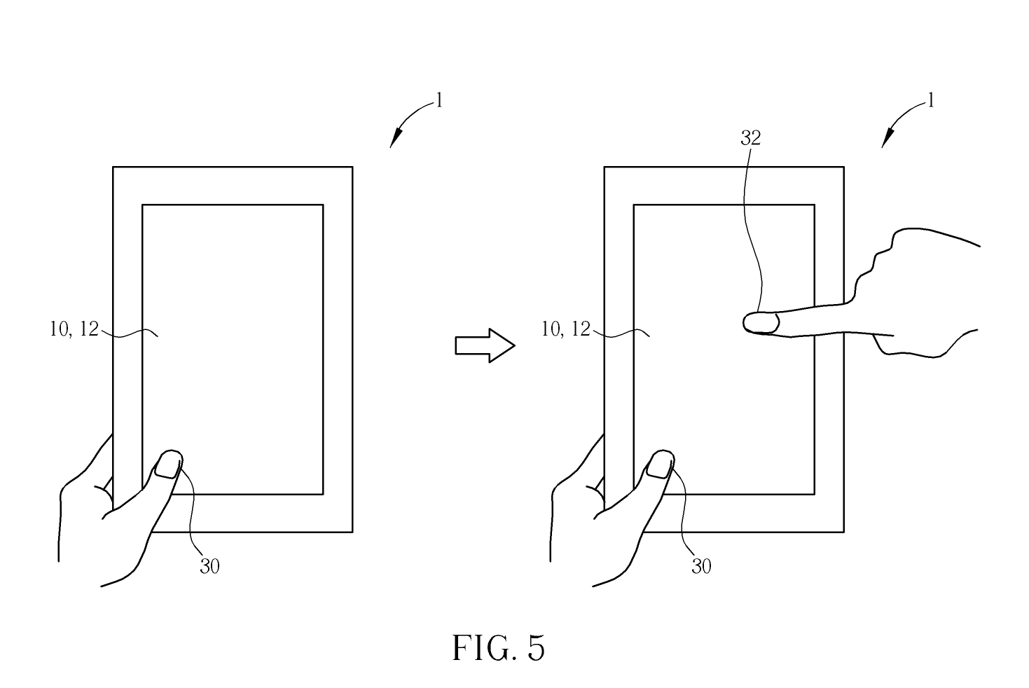

Referring to FIG. 5, FIG. 5 is a schematic diagram illustrating the touch display device 1 shown in FIG. 1 being used to execute a predetermined function, which is executed to change page in the application 132. As shown in FIG. 5, when a user wants to operate the touch display device 1 to execute a predetermined function, which is executed to change page in the application 132, he or she has to press a lower left corner (i.e. predetermined corner) of the touch panel 12 by a first touch object 30 first and then uses a second touch object 32 to slide on an operable region of the touch panel 12 (i.e. the aforesaid predetermined region is the operable region of the touch panel 12 and the aforesaid predetermined gesture is a slide gesture) while the first touch object 30 presses the lower left corner of the touch panel 12 continuously. Afterward, the processor 14 will change current page in the application 132 according to signals generated by the touch panel 12 (i.e. predetermined function). For example, when the first touch object presses the lower left corner of the touch panel 12 and the second touch object 32 slides on the operable region of the touch panel 12 leftward, the current page in the application 132 will be paged up; when the first touch object presses the lower left corner of the touch panel 12 and the second touch object 32 slides on the operable region of the touch panel 12 rightward, the current page in the application 132 will be paged down.

In this embodiment, the user can also press a lower right corner of the touch panel 12 by the first touch object 30 first and then uses the second touch object 32 to slide on the operable region of the touch panel 12, so as to change page in the application 132.

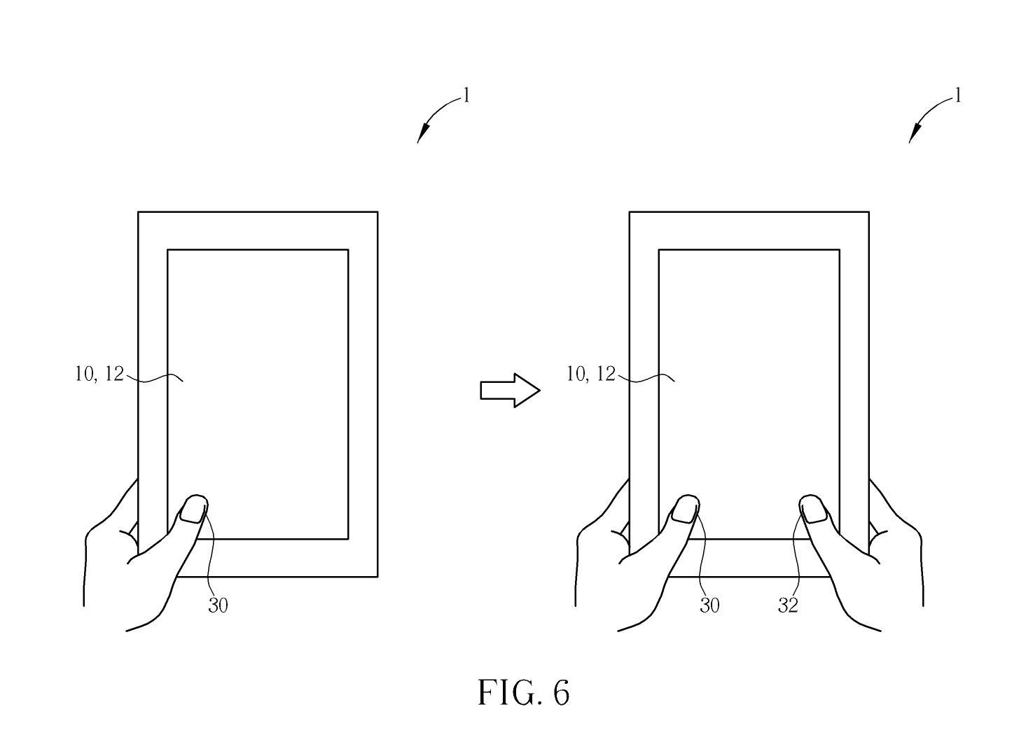

Referring to FIG. 6, FIG. 6 is a schematic diagram illustrating the touch display device 1 shown in FIG. 1 being used to execute a predetermined function, which is executed to change page between bottom and top in the application 132. As shown in FIG. 6, when a user wants to operate the touch display device 1 to execute a predetermined function, which is executed to change page between bottom and top in the application 132, he or she has to press a lower left corner (i.e. predetermined corner) of the touch panel 12 by a first touch object 30 first and then presses a lower right corner of the touch panel 12 by a second touch object 32 (i.e. the aforesaid predetermined region is the lower right corner of the touch panel 12 and the aforesaid predetermined gesture is a press gesture) while the first touch object 30 presses the lower left corner of the touch panel 12 continuously. Afterward, the processor 14 will change a current page displayed in the application to bottom according to signals generated by the touch panel 12 (i.e. predetermined function). It should be noted that if the current page displayed in the application 132 has been changed to bottom, the processor 14 will change the current page displayed in the application 132 from bottom to top according to signals generated by the touch panel 12.

In this embodiment, the user can also press the lower right corner of the touch panel 12 by the first touch object 30 first and then presses the lower left corner of the touch panel 12 by the second touch object 32, so as to change the current page displayed in the application 132 to bottom or from bottom to top.

In the aforesaid embodiments, the system can also change the current page displayed in the application 132 to top when the user presses an upper left corner of the touch panel 12 by the first touch object 30 first and then presses an upper right corner of the touch panel 12 by the second touch object 32. On the other hand, the system can also change the current page displayed in the application 132 to top when the user presses the upper right corner of the touch panel 12 by the first touch object 30 first and then presses the upper left corner of the touch panel 12 by the second touch object 32. If the current page displayed in the application 132 has been changed to top, the aforesaid operation will change the current page displayed in the application 132 from top to bottom. Therefore, the user can press the upper left corner and the upper right corner to change the current page to top and press the lower left corner and the lower right corner to change the current page to bottom such that the user may selectively change the current page between top and bottom. The user has to press two upper corners in order if he or she wants to change the current page to top and the user has to press two lower corners in order if he or she wants to change the current page to bottom.

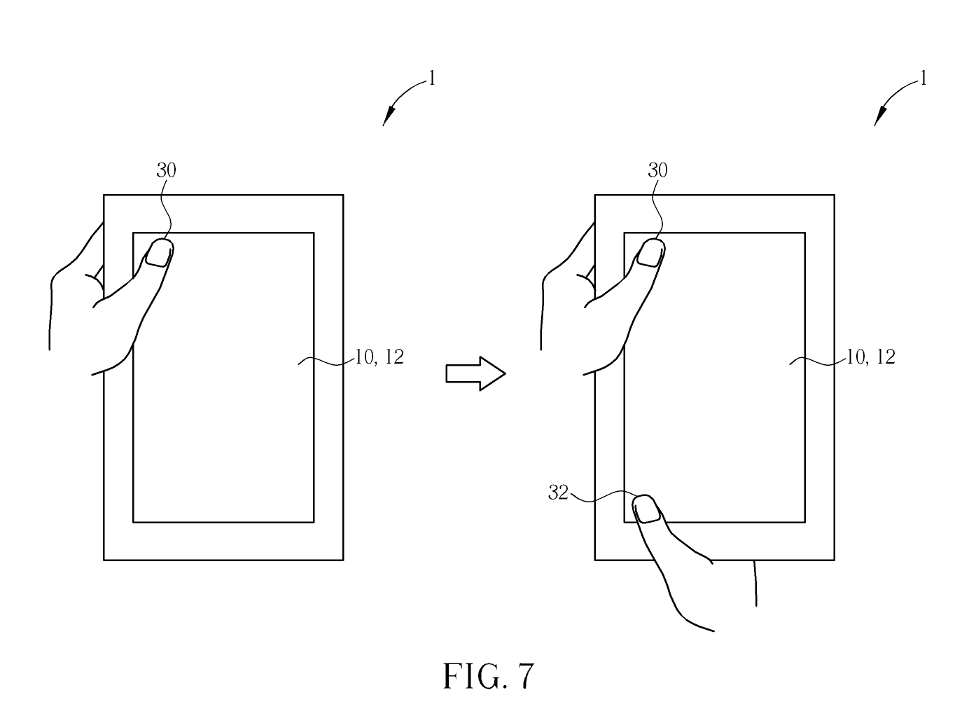

Referring to FIG. 7, FIG. 7 is a schematic diagram illustrating the touch display device 1 shown in FIG. 1 being used to execute a predetermined function, which is executed to open a new page in the application 132. As shown in FIG. 7, when a user wants to operate the touch display device 1 to execute a predetermined function, which is executed to open a new page in the application 132, he or she has to press an upper left corner (i.e. predetermined corner) of the touch panel 12 by a first touch object 30 first and then presses a lower left corner of the touch panel 12 by a second touch object 32 (i.e. the aforesaid predetermined region is the lower left corner of the touch panel 12 and the aforesaid predetermined gesture is a press gesture) while the first touch object 30 presses the upper left corner of the touch panel 12 continuously. Afterward, the processor 14 will open a new page in the application 132 according to signals generated by the touch panel 12 (i.e. predetermined function).

In this embodiment, the user can also press the lower left corner of the touch panel 12 by the first touch object 30 first and then presses the upper left corner of the touch panel 12 by the second touch object 32, so as to open a new page in the application 132.

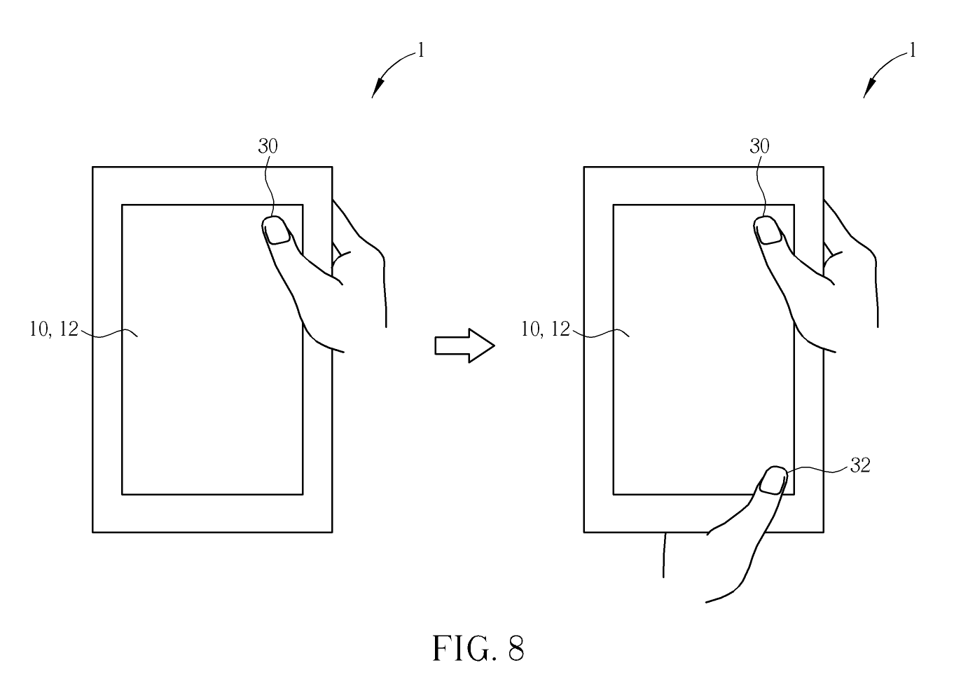

Referring to FIG. 8, FIG. 8 is a schematic diagram illustrating the touch display device 1 shown in FIG. 1 being used to execute a predetermined function, which is executed to close a current page in the application 132. As shown in FIG. 8, when a user wants to operate the touch display device 1 to execute a predetermined function, which is executed to close a current page in the application 132, he or she has to press an upper right corner (i.e. predetermined corner) of the touch panel 12 by a first touch object 30 first and then presses a lower right corner of the touch panel 12 by a second touch object 32 (i.e. the aforesaid predetermined region is the lower right corner of the touch panel 12 and the aforesaid predetermined gesture is a press gesture) while the first touch object 30 presses the upper left corner of the touch panel 12 continuously. Afterward, the processor 14 will close a current page in the application 132 according to signals generated by the touch panel 12 (i.e. predetermined function).

In this embodiment, the user can also press the lower right corner of the touch panel 12 by the first touch object 30 first and then presses the upper right corner of the touch panel 12 by the second touch object 32, so as to close a current page in the application 132.

Though the embodiment shown in FIG. 7 is to open a new page using the first touch object 30 and the second touch object 32 to press the upper left corner and the lower left corner and the embodiment shown in FIG. 8 is to close a current page using the first touch object 30 and the second touch object 32 to press the upper right corner and the lower right corner, the new page may be opened by pressing the upper right corner and the lower right corner and the current page may be closed by pressing the upper left corner and the lower left corner.

It should be noted that the touch gestures and related predetermined functions in the aforesaid embodiments may be default or set by the user. Furthermore, after booting the touch display device 1, the aforesaid touch function may be executed automatically. The user may also decide to open or close the aforesaid functions after booting. The aforesaid touch functions can be implemented by program codes.

As mentioned in the above, when a user wants to operate the touch display device of the invention to execute the predetermined function in the application (e.g. close the application, open new page, close current page, change page, etc.), he or she has to press the predetermined corner of the touch panel by the first touch object (e.g. one hand of the user) first and then performs the predetermined gesture within the predetermined region of the touch panel (e.g. press another corner of the touch panel or slide screen on the touch panel) by the second touch object (e.g. the other hand of the user). Afterward, the processor is triggered to execute the predetermined function in the application correspondingly. Accordingly, the user can utilize simple gesture to execute the predetermined function in the application instead of complicated and inconvenient operations of the prior art.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch display device comprising:
a display panel;
a touch panel;
a storage unit for storing an operating system and an application; and
a processor electrically connected to the display panel, the touch panel and the storage unit and used for executing the operating system and the application in the display panel;
wherein when the processor detects that a first touch object presses a predetermined corner of the touch panel and detects that a second touch object performs a predetermined gesture within a predetermined region of the touch panel, the processor executes a predetermined function in the application according to signals generated by the touch panel and controls the display panel to display an executed result corresponding to the predetermined function.

2. The touch display device of claim 1, wherein the predetermined corner is one of an upper left corner, a lower left corner, an upper right corner and a lower right corner of the touch panel, the predetermined region is a corner diagonal to the predetermined corner, the predetermined gesture is a press gesture, and the predetermined function is executed to close the application.

3. The touch display device of claim 1, wherein the predetermined corner is one of a lower left corner and a lower right corner of the touch panel, the predetermined region is an operable region of the touch panel, the predetermined gesture is a slide gesture, and the predetermined function is executed to change page in the application.

4. The touch display device of claim 3, wherein when the second touch object slides on the operable region of the touch panel leftward, the predetermined function is executed to page up; when the second touch object slides on the operable region of the touch panel rightward, the predetermined function is executed to page down.

5. The touch display device of claim 1, wherein the predetermined corner is one of a lower left corner and a lower right corner of the touch panel, the predetermined region is the other one of the lower left corner and the lower right corner of the touch panel, the predetermined gesture is a press gesture, and the predetermined function is executed to change a current page displayed in the application to bottom or change a current page displayed in the application from bottom to top.

6. The touch display device of claim 5, wherein the predetermined corner is one of an upper left corner and an upper right corner of the touch panel, the predetermined region is the other one of the upper left corner and the upper right corner of the touch panel, the predetermined gesture is a press gesture, and the predetermined function is executed to change a current page displayed in the application to top.

7. The touch display device of claim 1, wherein the predetermined corner is one of an upper left corner and a lower left corner of the touch panel, the predetermined region is the other one of the upper left corner and the lower left corner of the touch panel, the predetermined gesture is a press gesture, and the predetermined function is executed to open a new page in the application or close a current page displayed in the application.

8. The touch display device of claim 1, wherein the predetermined corner is one of an upper right corner and a lower right corner of the touch panel, the predetermined region is the other one of the upper right corner and the lower right corner of the touch panel, the predetermined gesture is a press gesture, and the predetermined function is executed to open a new page in the application or close a current page displayed in the application.

9. The touch display device of claim 1, wherein after the first touch object presses the predetermined corner of the touch panel, the processor determines whether the first touch object presses the predetermined corner over a predetermined time period continuously; once the first touch object presses the predetermined corner of the touch panel over the predetermined time period continuously, the processor determines whether the second touch object performs the predetermined gesture within the predetermined region of the touch panel; and once the second touch object performs the predetermined gesture within the predetermined region of the touch panel, the processor executes the predetermined function in the application according to signals generated by the touch panel.

10. A touch method adapted for a touch display device, the touch display device comprising a touch panel, an operating system and at least one application, the touch method comprising:
executing the operating system and the at least one application;
detecting whether a first touch object presses a predetermined corner of the touch panel;
detecting whether a second touch object performs a predetermined gesture within a predetermined region of the touch panel; and
executing a predetermined function in the application according to detection result correspondingly.

11. The touch method of claim 10, wherein the predetermined corner is one of an upper left corner, a lower left corner, an upper right corner and a lower right corner of the touch panel, the predetermined region is a corner diagonal to the predetermined corner, the predetermined gesture is a press gesture, and the predetermined function is executed to close the application.

12. The touch method of claim 10, wherein the predetermined corner is one of a lower left corner and a lower right corner of the touch panel, the predetermined region is an operable region of the touch panel, the predetermined gesture is a slide gesture, and the predetermined function is executed to change page in the application.

13. The touch method of claim 12, wherein when the second touch object slides on the operable region of the touch panel leftward, the predetermined function is executed to page up; when the second touch object slides on the operable region of the touch panel rightward, the predetermined function is executed to page down.

14. The touch method of claim 10, wherein the predetermined corner is one of a lower left corner and a lower right corner of the touch panel, the predetermined region is the other one of the lower left corner and the lower right corner of the touch panel, the predetermined gesture is a press gesture, and the predetermined function is executed to change a current page displayed in the application to bottom or change a current page displayed in the application from bottom to top.

15. The touch method of claim 14, wherein the predetermined corner is one of an upper left corner and an upper right corner of the touch panel, the predetermined region is the other one of the upper left corner and the upper right corner of the touch panel, the predetermined gesture is a press gesture, and the predetermined function is executed to change a current page displayed in the application to top.

16. The touch method of claim 10, wherein the predetermined corner is one of an upper left corner and a lower left corner of the touch panel, the predetermined region is the other one of the upper left corner and the lower left corner of the touch panel, the predetermined gesture is a press gesture, and the predetermined function is executed to open a new page in the application or close a current page displayed in the application.

17. The touch method of claim 10, wherein the predetermined corner is one of an upper right corner and a lower right corner of the touch panel, the predetermined region is the other one of the upper right corner and the lower right corner of the touch panel, the predetermined gesture is a press gesture, and the predetermined function is executed to open a new page in the application or close a current page displayed in the application.

18. The touch method of claim 10, further comprising:
after detecting that the first touch object presses the predetermined corner of the touch panel, determining whether the first touch object presses the predetermined corner over a predetermined time period continuously;
once the first touch object presses the predetermined corner of the touch panel over the predetermined time period continuously, determining whether the second touch object performs the predetermined gesture within the predetermined region of the touch panel; and
once the second touch object performs the predetermined gesture within the predetermined region of the touch panel, executing the predetermined function in the application according to signals generated by the touch panel.
